(19) United States
(12) Patent Application Publication
(10) Pub. No.: US 2022/0327394 A1
(43) Pub. Date: Oct. 13, 2022

(54) LEARNING SUPPORT APPARATUS, LEARNING SUPPORT METHODS, AND COMPUTER-READABLE RECORDING MEDIUM

(71) Applicant: NEC Corporation, Minato-ku,Tokyo (JP)

(72) Inventor: Yuta ASHIDA, Tokyo (JP)

(73) Assignee: NEC Corporation, Minato-ku, Tokyo (JP)

(21) Appl. No.: 17/618,098

(22) PCT Filed: Jun. 21, 2019
(86) PCT No.: PCT/JP2019/024832

§ 371 Date: Dec. 10, 2021

(51) Int. Cl. G06N 5/02

(52) U.S. Cl. CPC G06N 5/022

(57) ABSTRACT

A learning support apparatus 1 includes a feature pattern extraction unit 2 configured to extract a pattern of feature amounts that differentiates samples classified based on residuals using the classified samples and feature amounts used for learning a predictive model; and an error contribution calculation unit 3 configured to calculate an error contribution to a prediction error in the pattern of feature amounts using the extracted pattern of feature amounts and the residuals.

### TECHNICAL FIELD

The invention relates to a learning support apparatus and a learning support method that support learning of a prediction model, and further relates to a computer-readable recording medium that records a program for realizing these.

### BACKGROUND ART

It is general that the prediction model is evaluated using accuracy indexes averaging residuals (difference between a predicted value and an actual value) of all the learning samples (hereinafter referred to as samples), such as RMSE (Root Mean Squared Error) and MAE (Mean Absolute Error). It is possible to evaluate relative good/bad with other analysis results by calculating these accuracy indexes.

However, when the learned prediction model does not satisfy the desired accuracy, the calculated accuracy index does not include information used to infer causes of the prediction model not satisfying the accuracy. Therefore, it is difficult for a predictive analyst to consider what kind of learning should be given to the predictive model to improve the predictive accuracy.

As a related technique, Non-Patent Document 1 discloses a technique for presenting feature amount that differentiates a sample group including good prediction accuracy from a sample group including poor prediction accuracy in order to improve the accuracy of the learned prediction model.

According to the technique disclosed in Non-Patent Document 1, samples are first classified based on the residuals of each sample, and the samples are classified into a sample cluster including a large residual and a sample cluster including a small residual. Then, the distribution of the feature amount used in the prediction is estimated in each sample cluster.

Further, according to the technique disclosed in Non-Patent Document 1, the Kullback-Leibler divergence of the distribution of each feature amount estimated between the two sample clusters is calculated, and the distribution of the feature amount is visualized in descending order of Kullback-Leibler divergence. Thereby, for example, the predictive analyst can grasp the feature amount that differentiate the sample group including a large residual from the sample group including a small residual.

As described above, according to the technique disclosed in Non-Patent Document 1, it is possible to present a predictive analyst with feature amount that differentiate a sample group that is difficult to predict from a sample group that is easy to predict.

### LIST OF RELATED ART DOCUMENTS

### Non-Patent Document

Non-Patent document 1: Zhang, Jiawei, et al. “Manifold: A Model-Agnostic Framework for Interpretation and Diagnosis of Machine Learning Models.” IEEE transactions on visualization and computer graphics 25.1 (2019): 364-373.

### SUMMARY

### Technical Problems

However, the technique disclosed in Non-Patent Document 1 can only present to the predictive analyst with a single feature amount that differentiates the difficult-to-predict sample group from the easy-to-predict sample group. Therefore, the technique disclosed in Non-Patent Document 1 can deal with a case if it is possible to differentiate between the difficult-to-predict sample group from the easy-to-predict sample group based on only a single feature amount, however, it cannot deal with a case if it is possible to differentiate based on the combination of plurality of feature amounts.

Further, although the technique disclosed in Non-Patent Document 1 can present the feature amount that differentiates, however does not present information indicating whether the feature amount really contributes to the prediction error or not.

Further, since the technique disclosed in Non-Patent Document 1 does not provide information indicating countermeasures for improving accuracy, an analyst must consider the countermeasures.

An example of an object of the invention is to provide a learning support apparatus, a learning support method, and a computer-readable recording medium that generate information used to improve the prediction accuracy of a prediction model.

### Solution to the Problems

In order to achieve the above object, a learning support apparatus according to an example aspect of the invention includes:

a feature pattern extraction means for extracting a pattern of feature amounts that differentiates samples classified based on residuals using the classified samples and feature amounts used for learning a predictive model; and

an error contribution calculation means for calculating an error contribution to a prediction error in the pattern of feature amounts using the extracted pattern of feature amounts and the residuals.

Also, in order to achieve the above object, a learning support method according to an example aspect of the invention includes:

(a) extracting a pattern of feature amounts that differentiates samples classified based on residuals using the classified samples and feature amounts used for learning a predictive model; and

(b) calculating an error contribution to a prediction error in the pattern of feature amounts using the extracted pattern of feature amounts and the residuals.

Further, in order to achieve the above object, a computer-readable recording medium according to an example aspect of the invention includes a program recorded thereon, the program including instructions that cause a computer to carry out:

(a) extracting a pattern of feature amounts that differentiates samples classified based on residuals using the classified samples and feature amounts used for learning a predictive model; and

(b) calculating an error contribution to a prediction error in the pattern of feature amounts using the extracted pattern of feature amounts and the residuals.

### Advantageous Effects of the Invention

As described above, according to the present invention, it is possible to generate information used for improving the prediction accuracy of the prediction model.

### BRIEF DESCRIPTION OF THE DRAWINGS

FIG. 1 is a diagram showing an example of a learning support apparatus.

FIG. 2 is a diagram showing an example system including a learning support apparatus.

FIG. 3 is a diagram showing an example of a decision tree model for determining between a sample with a large error and a sample with a small error.

FIG. 4 is a diagram showing an example operation of a learning support apparatus according to the first example embodiment.

FIG. 5 is a diagram showing an example system including a learning support apparatus according to the second example embodiment.

FIG. 6 is a diagram showing an example operation of the learning support apparatus according to the second example embodiment.

FIG. 7 is a diagram showing an example system including a learning support apparatus according to the third example embodiment.

FIG. 8 is a diagram showing an example operation of the learning support apparatus according to the third example embodiment.

FIG. 9 is a diagram showing an example of a computer for realizing the learning support apparatus according to the first, second, and third example embodiments.

### EXAMPLE EMBODIMENT

### First Example Embodiment

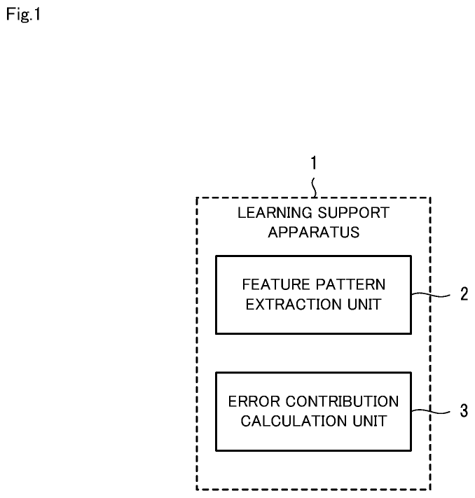

Hereinafter, the first example embodiment will be described with reference to FIGS. 1 to 3.

[Apparatus Configuration]

First, the configuration of the learning support apparatus 1 according to the first example embodiment will be described with reference to FIG. 1. FIG. 1 is a diagram showing an example of a learning support apparatus.

The learning support apparatus 1 shown in FIG. 1 is an apparatus that generates information used for improving the prediction accuracy of the prediction model. Further, as shown in FIG. 1, the learning support apparatus 1 includes a feature pattern extraction unit 2 and an error contribution calculation unit 3.

Of these, the feature pattern extraction unit 2 extracts a pattern of the feature amounts that differentiates samples classified based on residuals using the classified samples and feature amounts used for learning a predictive model. The error contribution calculation unit 3 calculates the error contribution to the prediction error of the feature pattern by using the extracted feature pattern and the residuals.

As described above, in the present example embodiment, it is possible to generate the information representing the pattern of feature amounts, the error contribution of the pattern of feature amounts, and the like, therefore it is possible to provide administrators, developers, analysts and other users with the information used to improve the prediction accuracy of the prediction model through an output device. Therefore, the users can easily perform the work of improving the prediction accuracy of the prediction model.

[System Configuration]

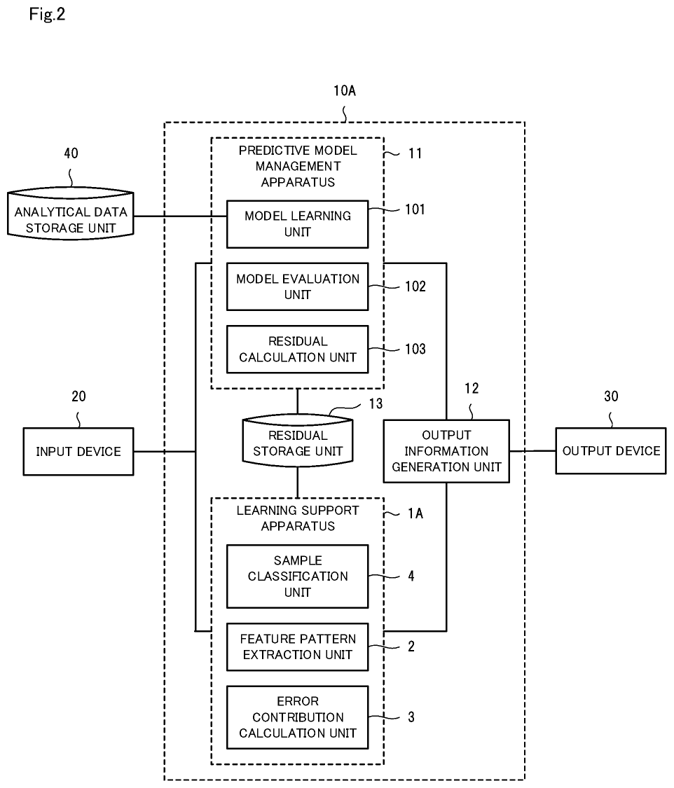

Subsequently, the configuration of the system including the learning support apparatus 1A in the first example embodiment will be described with reference to FIG. 2. FIG. 2 is a diagram showing an example system including a learning support apparatus according to the first example embodiment.

The system will be described.

As shown in FIG. 2, the system in the first example embodiment includes a prediction model management system 10A, an input device 20, an output device 30, and an analysis data storage unit 40.

In the learning phase, the prediction model management system 10A inputs a plurality of samples and generates a prediction model. In the operation phase, the prediction model management system 10A inputs the settings, feature amounts, objective variables, etc. used for the prediction analysis into the prediction model and performs the prediction analysis.

Further, the prediction model management system 10A evaluates the prediction accuracy of the prediction model after learning the prediction model. Further, the prediction model management system 10A calculates the residual for each sample after learning the prediction model.

Further, the prediction model management system 10A generates support information used for supporting the user's work and for improving the prediction accuracy of the prediction model, after learning the prediction model.

The prediction model management system 10A is, for example, an information processing device such as a server computer. The details of the prediction model management system 10A will be described below.

The input device 20 inputs the prediction analysis setting to the prediction model management system 10A. The predictive analysis setting is, for example, information used for setting parameters and models used for predictive analysis.

Further, the input device 20 inputs the sample classification setting to the learning support apparatus 1A. The sample classification setting is, for example, information for setting parameters, a classification method, and the like used for classifying samples. The input device 20 is, for example, an information processing device such as a personal computer.

The output device 30 acquires the output information converted into an outputable format by the output information generation unit 12, and outputs the generated image, sound, and the like based on the acquired output information. The output information generation unit 12 will be described below.

The output device 30 is, for example, an image display device using a liquid crystal display, an organic EL (Electro Luminescence), or a CRT (Cathode Ray Tube). Further, the image display device may include an audio output device such as a speaker. The output device 30 may be a printing device such as a printer.

The analysis data storage unit 40 stores the analysis data (feature amount (explanatory variable) and prediction target data (objective variable) for each sample) used in the prediction model management apparatus 11 and the learning support apparatus 1A. The analysis data storage unit 40 is, for example, a storage device such as a database. Although the analysis data storage unit 40 is provided outside the prediction model management system 10A in the example of FIG. 2, it may be provided inside the prediction model management system 10A.

The prediction model management system will be described.

The prediction model management system 10A includes a prediction model management apparatus 11, an output information generation unit 12, a residual storage unit 13, and a learning support apparatus 1A.

The prediction model management apparatus 11 acquires the prediction analysis setting information from the input device 20 in the operation phase. Further, the prediction model management apparatus 11 acquires information such as objective variables and feature amounts used for prediction analysis from the analysis data storage unit 40 in the operation phase. After that, the prediction model management apparatus 11 executes the prediction analysis using the acquired information, and stores the prediction analysis result in a storage unit (not shown).

The learning, evaluation, and residual processing of the prediction model executed by the prediction model management apparatus 11 will be described below.

The output information generation unit 12 generates output information outputable to output device 30 by converting the information to be output to the output device 30, that is, the information to be presented to the user. The information to be presented to the user is, for example, information such as the evaluation result of the prediction model learned by the model learning unit 101, the classification result calculated by the sample classification unit 4, the pattern of the feature amounts extracted by the feature pattern extraction unit 2, and the error contribution, the error contribution calculated by the degree calculation unit 3.

The residual storage unit 13 stores the residuals of the prediction model calculated by the residual calculation unit 103. The residual storage unit 13 is, for example, a storage device such as a database. Although the residual storage unit 13 is provided outside the prediction model management apparatus 11 in FIG. 2, it may be provided inside the prediction model management apparatus 11.

The learning support apparatus 1A generates information used by the user in order to improve the prediction accuracy of the prediction model. The learning support apparatus 1A may be provided in the prediction model management system 10A or may be provided outside the prediction model management system 10A. The learning support apparatus 1A will be described below.

The prediction model management apparatus will be described.

The prediction model management apparatus 11 includes a model learning unit 101, a model evaluation unit 102, and a residual calculation unit 103.

In the learning phase, the model learning unit 101 receives information such as learning execution instructions to execute learning on the prediction model, learning settings used for learning the prediction model, and samples used for learning from the analysis data storage unit 40. The learning settings are information such as, for example, a base model, a learning algorithm specification, and hyperparameters of the learning process.

Subsequently, the model learning unit 101 executes learning of the prediction model using the acquired information, and generates a prediction model. The model learning unit 101 stores the generated prediction model in a storage unit provided inside the prediction model management apparatus 11 or a storage unit (not shown) provided outside the prediction model management apparatus 11.

The model evaluation unit 102 evaluates performance such as an error of the prediction model learned by the model learning unit 101. Specifically, the model evaluation unit 102 calculates the evaluation value of the prediction model, that is, the value used for error evaluation such as RMSE and a value (for example, plausibility) used for learning end determination of the learning algorithm after learning the prediction model.

The residual calculation unit 103 calculates the residual for each sample of the prediction model learned by the model learning unit 101. Specifically, after learning the prediction model, the residual calculation unit 103 uses the learned prediction model, and calculates the residual during the execution of the prediction, that is, the difference between the predicted value and the actual value for each sample (=Actual Value−Predicted Value).

The evaluation of the prediction model and the calculation of the residuals described above are performed for each learning case set and test case set. Further, for example, a random forest, GBDT (Gradient Boosting Decision Tree), Deep Neural Network, or the like may be used as the learning algorithm and the base model used for learning the prediction model.

The learning support apparatus will be explained.

The learning support apparatus 1A includes a sample classification unit 4 in addition to the feature pattern extraction unit 2 and the error contribution calculation unit 3.

The sample classification unit 4 classifies the sample based on the residual using the sample classification setting and the information representing the residual. Specifically, the sample classification unit 4 first acquires the sample classification setting from the input device 20 and the residuals for each sample stored in the residual storage unit 13.

Subsequently, the sample classification unit 4 divides the sample using the parameters of the sample classification setting. The parameter is, for example, a threshold value used to classify a sample group in which the prediction is successful and a sample group in which the prediction is unsuccessful. The threshold value is obtained by using, for example, an experiment or a simulation.

Further, the sample classification unit 4 may be classified by using a clustering method such as the Kmeans method. In that case, the parameter is the number of clusters.

The feature pattern extraction unit 2 extracts a pattern of the feature amount for differentiating the sample group. Specifically, the feature pattern extraction unit 2 first acquires the classification result classified by the sample classification unit 4 and the feature amount used for learning the prediction model stored in the analysis data storage unit 40.

Subsequently, the feature pattern extraction unit 2 extracts a pattern of the feature amount that differentiates the sample group by using the sample group including a large residual as the classification result and the feature amount used for learning the prediction model.

A method of extracting a pattern of feature amounts applying a decision tree will be described.

For example, a sample with a large prediction error is used as a positive example, a sample with a small prediction error is used as a negative example, and a feature amount used for learning a prediction model is used as an explanatory variable to learn a decision tree for determining between a positive example and a negative example.

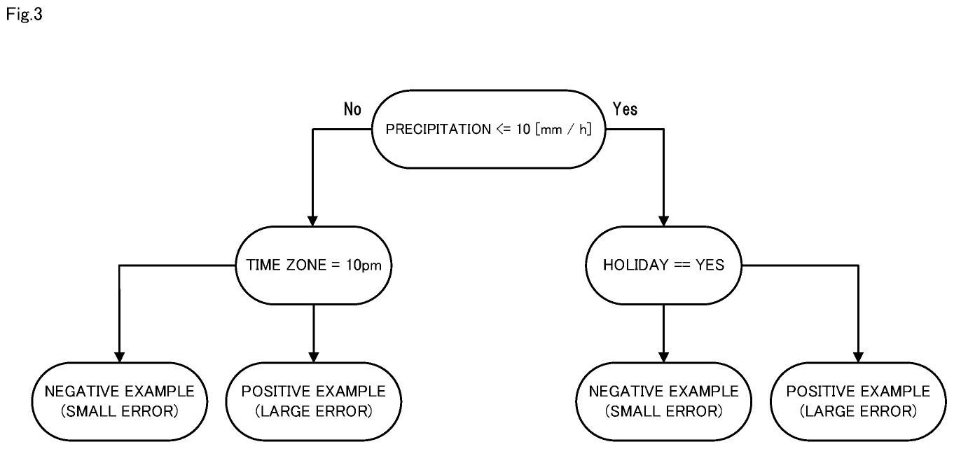

FIG. 3 is a diagram showing an example of a decision tree model for determining between a sample with a large error and a sample with a small error. In the example of FIG. 3, in the learned decision tree, each node except the leaf node (positive example and negative example of FIG. 3) is associated with the feature amount condition used for determining between the positive example and the negative example.

FIG. 3 shows a rule that; when the precipitation amount is 10 [mm/h] or less in the root node (Yes), it shifts to the right child node, and in other cases (No), it shifts to the left child node. That is, the root node is associated with whether the sample classified by the determination rule is a positive example or a negative example.

Further, by tracing the decision tree of FIG. 3 in the reverse direction from the leaf node to the root node, it is possible to extract by what rule can determine the positive example and the negative example. The rule obtained from the leaf node on the far right in FIG. 3 is defined as “the prediction target is a holiday and the precipitation is 10 [mm/h] or less”. In this way, the above-mentioned rule is extracted as a pattern of feature amounts used to explain each cluster.

Although the example of determining two clusters of a sample with a large error and a sample with a small error is shown in FIG. 3, two or more clusters may be used. Also, the cluster may be generated based on largeness of the error. Further, it is possible to determine the clusters obtained from each of the learning case and the test case at the same time.

Next, a feature pattern extraction method using a frequent item set will be described. For example, it is possible to use an apriori algorithm or the like. In this method, as a first step, a frequent item set in each of a cluster of samples with a large error and a cluster of samples with a small error is extracted using the apriori algorithm.

In the first step, among the feature amounts used in the predictive analysis, those including continuous values are discretized by binning processing. The binning process is a process used to discretize continuous variables. For example, when a certain feature amount has a value of 0 to 99, the range is divided into 10 and divided into widths of 0 to 9, 10 to 19, . . . 90 to 99.

Subsequently, if the feature amount of a sample has a value of 5, the feature amount is converted into a label of “0 to 9”. As this label, “0 to 9” may be used as it is, or any uniquely identifiable label may be used, such as each range may be 0, 1, 2 . . . , or A, B, C . . . in the order of the divided range. By this process, all feature amounts including continuous values are converted into feature amounts including discrete values.

Next, as second step, a frequent item set is extracted from each of a cluster of samples including a large error and a cluster of samples including a small error using the apriori algorithm. The frequent item set is a transaction possessed by each sample, and is an item possessed by a large number of samples in the discretized feature amounts. Here, the item refers to the value of the feature amount, and the item set refers to the combination of the values of the feature amount.

Frequent item sets extracted from clusters of samples with large errors are a combination of feature amounts that most of the samples with large errors have in common, and can be used as a pattern of feature amounts of samples with large errors. A frequent item set extracted from a cluster of samples with a small error can also be used as a pattern of feature amounts of a sample group with a small error.

In the second step, the apriori algorithm first searches for an item of length 1. That is, in all the samples in the cluster, the value of the feature amount including an appearance frequency of frequency α or more is extracted and used as a frequent set F_1 including a length of 1.

Next, all the items obtained by adding one item to F_1 and including a length of 2, that is, a combination of two feature amounts are listed. For each item of length 2, it is determined whether an item from which one of the elements has been removed is included in F_1, and if it is not included, it is rejected.

Subsequently, with respect to the remaining items including a length of 2, the items including a frequency of α or more are left, and this is designated as F_2. The same operation is continued until the length becomes k. By doing so, it is possible to extract a pattern of frequently appearing feature amounts by combining k feature amounts. In addition, the feature pattern extraction unit 2 compares the pattern sets of the feature amounts extracted for each cluster, and extracts the pattern of the feature amount unique to each cluster.

The error contribution calculation unit 3 calculates the error contribution (relevance) of the pattern of the feature amount extracted by the feature pattern extraction unit 2. Specifically, the error contribution calculation unit 3 first acquires the pattern of the feature amount extracted by the feature pattern extraction unit 2 and the residuals calculated by the residual calculation unit 103. Subsequently, the error contribution calculation unit 3 calculates the error contribution of the pattern of feature amounts using the acquired pattern of feature amount and the residual. That is, the effect of the existence of the pattern of each feature amount on the overall prediction error is calculated.

The calculation of the relevance is, for example, a correlation coefficient. For each sample, it is associated with the presence or absence of a pattern P of a certain feature amount. For example, if it is 1, it is associated with occurrence, and if it is 0, it is associated with non-occurrence.

Kendall rank correlation coefficient or Spearman's rank correlation coefficient is calculated based on the presence or absence of this feature pattern and the residual for each sample, and thereby, the change in error depending on the presence or absence of the feature pattern is calculated.

Moreover, the learning algorithm of an arbitrary prediction model may be used for the calculation of the relevance. The prediction model is learned with the presence or absence of the pattern for each feature amount for each sample as the feature amount and the residual for each sample as the objective variable.

The error contribution can be calculated by extracting the contribution of the feature pattern when the residual is predicted based on this prediction model. For example, when the residual is predicted using linear regression, the regression coefficient can be regarded as the error contribution.

[Apparatus Operation]

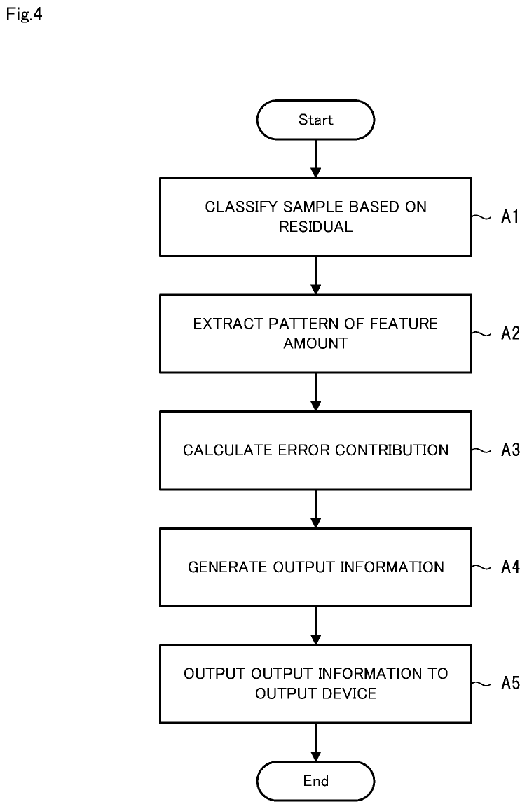

Next, the operation of the learning support apparatus according to the first example embodiment will be described with reference to FIG. 4. FIG. 4 is a diagram showing an example operation of the learning support apparatus according to the first example embodiment. In the following description, FIGS. 2 to 3 will be referred to as needed in the following description. Further, in the first example embodiment, the learning support method is implemented by causing the learning support apparatus to operate. Accordingly, the following description of the operations of the learning support apparatus is substituted for the description of the learning support method in the first example embodiment.

As shown in FIG. 3, first, the sample classification unit 4 classifies the sample based on the residual using the sample classification setting and the information representing the residual (step A1). Specifically, in step A1, the sample classification unit 4 first acquires the sample classification setting from the input device 20 and the residuals for each sample stored in the residual storage unit 13.

Subsequently, in step A1, the sample classification unit 4 divides the sample using the parameters of the sample classification setting. The parameter is, for example, a threshold value used to classify a sample group in which the prediction is successful and a sample group in which the prediction is unsuccessful. The threshold value is obtained by using, for example, an experiment or a simulation.

Further, the sample classification unit 4 may be classified by using a clustering method such as the Kmeans method. In that case, the parameter is the number of clusters.

Next, the feature pattern extraction unit 2 extracts a pattern of feature amounts for differentiating the sample group (step A2). Specifically, in step A2, the feature pattern extraction unit 2 first acquires the classification result classified by the sample classification unit 4 and the feature amount used for learning the prediction model stored in the analysis data storage unit 40.

Subsequently, in step A2, the feature pattern extraction unit 2 extracts a pattern of the feature amount that differentiates the sample group by using the sample group including a large residual as the classification result and the feature amount used for learning the prediction model.

Next, the error contribution calculation unit 3 calculates the error contribution (relevance) of the pattern of feature amounts extracted by the feature pattern extraction unit 2 (step A3). Specifically, in step A3, the error contribution calculation unit 3 first acquires the pattern of the feature amount extracted by the feature pattern extraction unit 2 and the residual calculated by the residual calculation unit 103.

Subsequently, in step A3, the error contribution calculation unit 3 calculates the error contribution of the pattern of feature amounts using the acquired pattern of feature amount and the residual. That is, the effect of the existence of the pattern of each feature amount on the overall prediction error is calculated.

Next, the output information generation unit 12 generates output information outputable to output device 30 by converting the information to be output to the output device 30, that is, the information to be presented to the user (step A4). Next, the output information generation unit 12 outputs the generated output information to the output device 30 (step A5).

The information to be presented to the user is, for example, information such as the evaluation result of the prediction model learned by the model learning unit 101, the classification result calculated by the sample classification unit 4, the pattern of the feature amounts extracted by the feature pattern extraction unit 2, and the error contribution, the error contribution calculated by the degree calculation unit 3.

[Effect of the First Example Embodiment]

As described above, according to the first example embodiment, it is possible to generate information such as a pattern of feature amounts and an error contribution of the pattern of feature amounts. Therefore, it is possible to provide the user with the information used to improve the prediction accuracy of the prediction model through the input device 20. Therefore, the user can easily perform the work of improving the prediction accuracy of the prediction model.

[Program]

A program in the first example embodiment may be a program that causes a computer to execute steps A1 to A5 shown in FIG. 4. It is possible to realize the learning support apparatus and learning support method according to the first example embodiment by installing this program onto a computer and executing the program. If this is the case, the processor of the computer functions as the sample classification unit 4, the feature pattern extraction unit 2, the error contribution calculation unit 3, and the output information generation unit 12, and executes processing.

Also, the program according to the first example embodiment may be executed by a computer system constructed with a plurality of computers. In this case, for example, the computers may respectively function as the sample classification unit 4, the feature pattern extraction unit 2, the error contribution calculation unit 3, and the output information generation unit 12.

### Second Example Embodiment

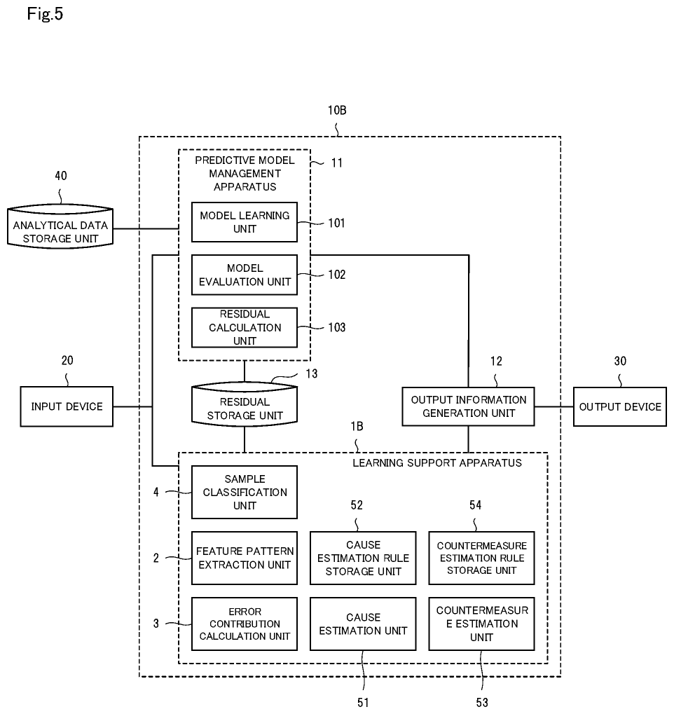

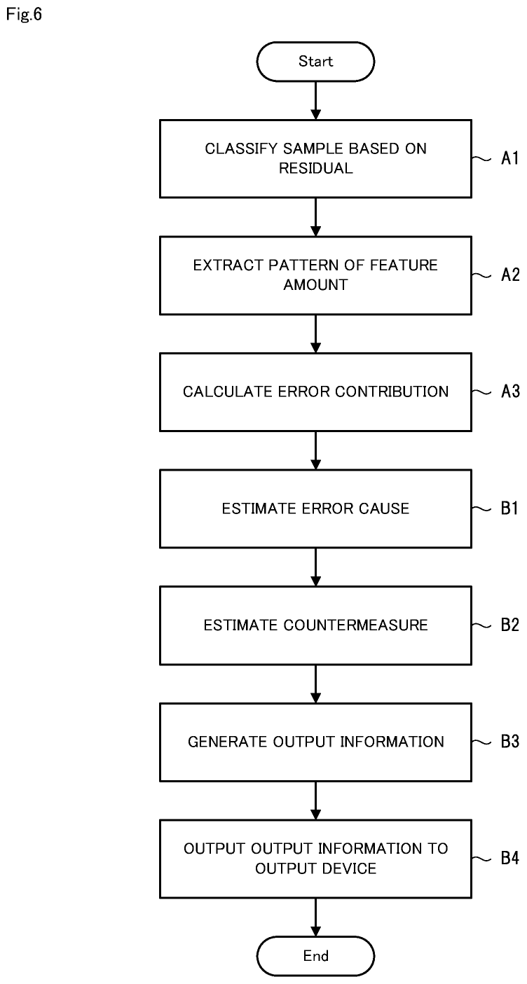

Hereinafter, the second example embodiment will be described with reference to FIGS. 5 to 6.

The second example embodiment estimates not only the pattern of feature amounts and the error contribution of the pattern of feature amounts, but also the error cause and countermeasures for solving the cause.

[System Configuration]

Subsequently, the configuration of the system including the learning support apparatus 1B in the second example embodiment will be described with reference to FIG. 5. FIG. 5 is a diagram showing an example system including a learning support apparatus according to the second example embodiment.

The system will be described.

As shown in FIG. 5, the system in the second example embodiment includes a prediction model management system 10B, an input device 20, an output device 30, and an analysis data storage unit 40. The prediction model management system 10B includes a prediction model management apparatus 11, an output information generation unit 12, a residual storage unit 13, and a learning support apparatus 1B. The prediction model management apparatus 11 has a model learning unit 101, a model evaluation unit 102, and a residual calculation unit 103.

The explanation regarding the above-mentioned input device 20, output device 30, analysis data storage unit 40, prediction model management apparatus 11, output information generation unit 12, and residual storage unit 13 is omitted because these are explained in the first example embodiment.

The learning support apparatus will be explained.

The learning support apparatus 1B includes a cause estimation unit 51, a cause estimation rule storage unit 52, a countermeasure estimation unit 53, and a countermeasure estimation rule storage unit 54 in addition to the feature pattern extraction unit 2, the error contribution calculation unit 3, and the sample classification unit 4.

The explanation regarding the above-mentioned the feature pattern extraction unit 2, the error contribution calculation unit 3, and the sample classification unit 4 is omitted because these are explained in the first example embodiment.

The cause estimation unit 51 estimates the error cause by using cause estimation rule and the pattern of feature amounts. Specifically, the cause estimation unit 51 first acquires the cause estimation rule stored in the cause estimation rule storage unit 52 and the pattern of feature amounts calculated by the feature pattern extraction unit 2.

Subsequently, the cause estimation unit 51 applies the pattern of feature amounts to the cause estimation rule to estimate the error cause. The cause estimation rule is a rule for estimating the cause of an error using a feature pattern. The error cause is, for example, a covariate shift, a class balance change, an imbalance label, and the like.

The covariate shift means a case in which the probability distribution of the feature amounts differs between the data used for learning and the set of test data and new data in operation for one or more feature amounts. When a covariate shift occurs, it is different in two data sets between a possible range of an average value of the feature amounts of each set. As a result, the input data changes to an unknown region in the prediction model learned using the data used for learning, so that the prediction accuracy decreases.

The class balance change means that the distribution of the objective variable changes, unlike the covariate shift. Even the class balance change, the prediction accuracy decreases because the environment changes to areas that cannot be handled by the learned prediction model.

The imbalance label means that the number of samples in the area taken by the objective variable is significantly different, which is common with the learning data and the test data. For example, in the case of a binary determination task, the positive example is 1[%] of all samples, and the negative example is 99[%]. Examples include disease recognition using images and detection of fraudulent use of credit cards. In such a case, the prediction accuracy of Frey, which occupies the majority, becomes dominant in the learning process, the prediction accuracy of the positive example is neglected, and the prediction accuracy of the whole decreases.

The cause estimation rule storage unit 52 stores the cause estimation rule used for estimating the error cause. The cause estimation rule storage unit 52 is, for example, a storage device such as a database. Although the cause estimation rule storage unit 52 is provided inside the learning support apparatus 1B in FIG. 5, it may be provided outside the learning support apparatus 1B.

Specifically, the cause estimation rule may be stored in the cause estimation rule storage unit 52 by the user in advance or during operation.

A comparison of pattern of feature amounts between the learning set and the test set is possible to be considered as the cause estimation rule. For example, when the sample classification unit 4 and the feature pattern extraction unit 2 target clusters with a large error in the learning set, clusters with a small error in the learning set, clusters with a large error in the test set, and clusters with a small error in the test set, the feature pattern extraction unit 2 extracts a pattern of a feature amount unique to each cluster.

The unique feature pattern of the cluster with a large error in the test set shows value of the feature amount having only the sample of the cluster with a large error, and it is possible to be determined that the learning data does not include the sample with value of this feature amount. Thereby, it is possible to specify the error based on the covariate shift. The cause estimation rule may use various findings accumulated in the analysis task.

The countermeasure estimation unit 53 estimates the countermeasures by using the countermeasure estimation rule and the pattern of feature amount. Specifically, the countermeasure estimation unit 53 first acquires the countermeasure estimation rule stored in the countermeasure estimation rule storage unit 54 and the pattern of feature amounts calculated by the feature pattern extraction unit 2.

Subsequently, the countermeasure estimation unit 53 applies the pattern of feature amount to the countermeasure estimation rule to estimate the countermeasure. In the case of an error generated from the covariate shift described above, for example, it is possible to be illustrated as countermeasure, that the prediction model may be relearned by appropriately exchanging the samples of the learning set and the test set.

The countermeasure estimation rule storage unit 54 stores a rule for estimating countermeasures necessary for reducing the prediction error. The countermeasure estimation rule storage unit 54 is, for example, a storage device such as a database. Although the countermeasure estimation rule storage unit 54 is provided inside the learning support apparatus 1B in FIG. 5, it may be provided outside the learning support apparatus 1B.

Specifically, the countermeasure estimation rule may be stored in the countermeasure estimation rule storage unit 54 by the user in advance or during operation.

It is possible to be considered as the countermeasure estimation rule, for example, as same as the cause estimation rule, that unique feature patterns with large and small errors between learning data and test data are compared and the samples are replaced. In addition, the countermeasure estimation rule may use other knowledge of the user.

The output information generation unit 12 generates output information outputable to output device 30 by converting the information to be output to the output device 30, that is, the information to be presented to the user. The information to be presented to the user is, for example, information such as the evaluation result of the prediction model learned by the model learning unit 101, the classification result calculated by the sample classification unit 4, the pattern of the feature amounts extracted by the feature pattern extraction unit 2, and the error contribution calculated by the degree calculation unit 3, and further information such as error causes and countermeasures.

[Apparatus Operation]

Next, the operation of the learning support apparatus according to the second example embodiment will be described with reference to FIG. 6.FIG. 6 is a diagram showing an example operation of the learning support apparatus according to the second example embodiment. In the following description, FIG. 5 will be referred to as needed in the following description. Further, in the second example embodiment, the learning support method is implemented by causing the learning support apparatus to operate. Accordingly, the following description of the operations of the learning support apparatus is substituted for the description of the learning support method in the second example embodiment.

As shown in FIG. 6, first, the processes of steps A1 to A3 are executed.

Since the processes of steps A1 to A3 have been described in the first example embodiment, the processes of steps A1 to A3 will be omitted.

Next, the cause estimation unit 51 estimates the error cause by using the cause estimation rule and the pattern of feature amounts (step B1). Specifically, in step B1, the cause estimation unit 51 first acquires the cause estimation rule stored in the cause estimation rule storage unit 52 and the pattern of feature amounts calculated by the feature pattern extraction unit 2.

Subsequently, in step B1, the cause estimation unit 51 applies the pattern of feature amounts to the cause estimation rule to estimate the error cause. The cause estimation rule is a rule for estimating the cause of an error using a feature pattern. The error cause is, for example, a covariate shift, a class balance change, an imbalance label, and the like.

Next, the countermeasure estimation unit 53 estimates the countermeasure by using the countermeasure estimation rule and the pattern of feature amount (step B2). Specifically, in step B2, the countermeasure estimation unit 53 first acquires the countermeasure estimation rule stored in the countermeasure estimation rule storage unit 54 and the pattern of feature amounts calculated by the feature pattern extraction unit 2.

Subsequently, in step B2, the countermeasure estimation unit 53 applies the pattern of feature amount to the countermeasure estimation rule to estimate the countermeasure. In the case of an error generated from the covariate shift described above, for example, it is possible to be illustrated as countermeasure, that the prediction model may be relearned by appropriately exchanging the samples of the learning set and the test set. The order of steps B1 and B2 may be reversed.

Next, the output information generation unit 12 generates output information outputable to output device 30 by converting the information to be output to the output device 30, that is, the information to be presented to the user (step B3). Next, the output information generation unit 12 outputs the generated output information to the output device 30 (step B4).

The information to be presented to the user is, for example, information such as the evaluation result of the prediction model learned by the model learning unit 101, the classification result calculated by the sample classification unit 4, the pattern of the feature amounts extracted by the feature pattern extraction unit 2, the error contribution calculated by the degree calculation unit 3, error causes and countermeasures.

[Effect of the First Example Embodiment]

As described above, according to the second example embodiment, it is possible to generate information such as a pattern of feature amounts and an error contribution of the pattern of feature amounts. Therefore, it is possible to provide the user with the information used to improve the prediction accuracy of the prediction model through the output device 30. Therefore, the user can easily perform the work of improving the prediction accuracy of the prediction model.

Further, according to the second example embodiment, it is possible to estimate the error cause and the countermeasure for solving the error cause. Therefore, it is possible to generate information of not only the pattern of feature amount and the error contribution of the pattern of feature amount but also information such as the error cause and the countermeasures. Therefore, the information used for improving the prediction accuracy of the prediction model can be further provided to the user through the output device 30. Therefore, the user can easily perform the work of improving the prediction accuracy of the prediction model.

[Program]

A program in the second example embodiment may be a program that causes a computer to execute steps A1 to A5 and steps B1 to B4 shown in FIG. 6. It is possible to realize the learning support apparatus and learning support method according to the second example embodiment by installing this program onto a computer and executing the program. If this is the case, the processor of the computer functions as the sample classification unit 4, the feature pattern extraction unit 2, the error contribution calculation unit 3, the cause estimation unit 51, the countermeasure estimation unit 53, and the output information generation unit 12, and executes processing.

Also, the program according to the second example embodiment may be executed by a computer system constructed with a plurality of computers. In this case, for example, the computers may respectively function as the sample classification unit 4, the feature pattern extraction unit 2, the error contribution calculation unit 3, the cause estimation unit 51, the countermeasure estimation unit 53, and the output information generation unit 12.

### Third Example Embodiment

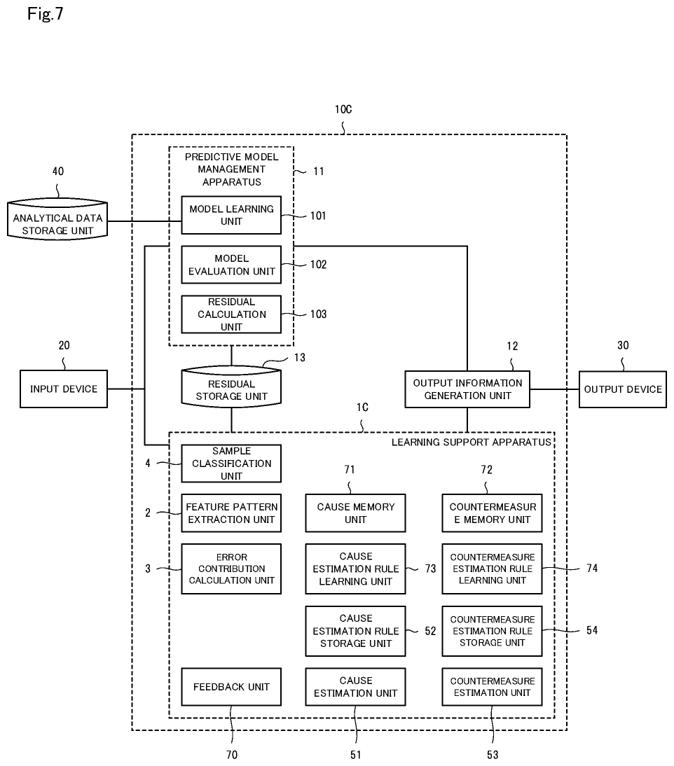

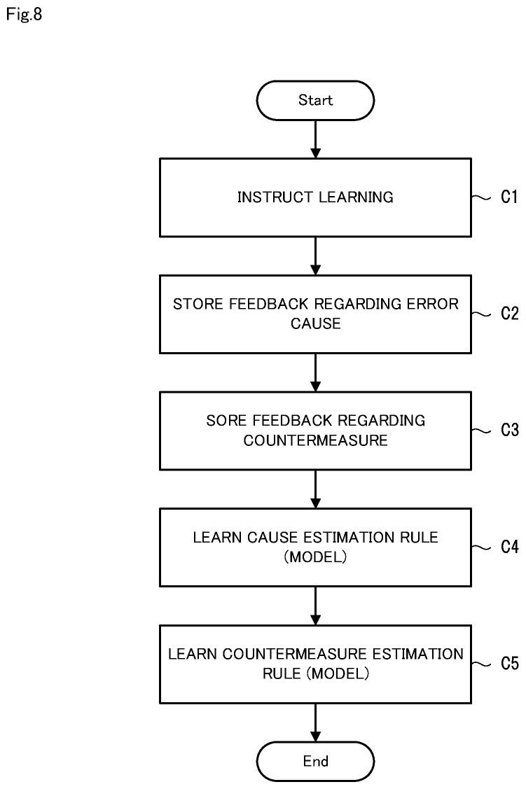

Hereinafter, the third example embodiment will be described with reference to FIGS. 7 to 8.

The third example embodiment accumulates the error cause, the countermeasure considered to be effective, and the pattern of feature amounts, and generates the error cause estimation rule and the countermeasure estimation rule by using the accumulated error cause, the countermeasure, and the pattern of feature amounts.

### [System Configuration]

Subsequently, the configuration of the system including the learning support apparatus 1C in the third example embodiment will be described with reference to FIG. 7. FIG. 7 is a diagram showing an example system including a learning support apparatus according to the third example embodiment.

The system will be described.

As shown in FIG. 7, the system according to the third example embodiment includes a prediction model management system 10C, an input device 20, an output device 30, and an analysis data storage unit 40. The prediction model management system 10C includes a prediction model management apparatus 11, an output information generation unit 12, a residual storage unit 13, and a learning support apparatus 1C. The prediction model management apparatus 11 includes a model learning unit 101, a model evaluation unit 102, and a residual calculation unit 103.

The explanation regarding the above-mentioned input device 20, output device 30, analysis data storage unit 40, prediction model management apparatus 11, output information generation unit 12, and residual storage unit 13 is omitted because these are explained in the first example embodiment.

The learning support apparatus will be described.

The learning support apparatus 1C includes a feature pattern extraction unit 2, an error contribution calculation unit 3, a sample classification unit 4, a cause estimation unit 51, a cause estimation rule storage unit 52, a countermeasure estimation unit 53, and a countermeasure estimation rule storage unit 54, and further includes a feedback unit 70, a cause storage unit 71, a countermeasure storage unit 72, a cause estimation rule learning unit 73, and a countermeasure estimation rule learning unit 74.

The explanation regarding above-mentioned the feature pattern extraction unit 2, the error contribution calculation unit 3, and the sample classification unit 4 is omitted because these are explained in the first example embodiment.

Further, the explanation regarding above-mentioned the cause estimation unit 51, the cause estimation rule storage unit 52, the countermeasure estimation unit 53, and the countermeasure estimation rule storage unit 54 is omitted because these are explained in the second example embodiment.

The feedback unit 70 stores in the storage unit the error cause, the countermeasure, the pattern of feature amounts, etc. estimated by the learning support apparatus 1C. Specifically, the feedback unit 70 acquires the error cause estimated by the cause estimation unit 51, the countermeasure estimated by the countermeasure estimation unit 53, and the pattern of feature amounts extracted by the feature pattern extraction unit 2.

Subsequently, the feedback unit 70 stores the error cause and the corresponding pattern of feature amounts in association with the cause storage unit 71. Further, the feedback unit 70 stores in the countermeasure storage unit 72 the countermeasure for improving the error and the corresponding pattern of feature amounts in association with each other.

The feedback unit 70 may acquire an error cause, a countermeasure, and a pattern of feature amounts from the input device 20 and store them in the storage unit.

The cause storage unit 71 stores, for example, an error cause and a corresponding pattern of feature amounts in association with each other as feedback.

Further, the cause storage unit 71 is, for example, a storage device such as a database. Although the cause storage unit 71 is provided inside the learning support apparatus 1C in FIG. 7, it may be provided outside the learning support apparatus 1C.

The countermeasure storage unit 72 stores, for example, a countermeasure for improving an error and a corresponding pattern of feature amounts in association with each other as feedback. The countermeasure storage unit 72 may further store the effectiveness of the countermeasure (improvement of prediction) in association with the countermeasure and the pattern of the feature amount thereof.

The effectiveness the countermeasure is calculated by using the evaluation value of the prediction model calculated by the model evaluation unit 102, the residual for each sample calculated by the residual calculation unit 103, the pattern of the feature amount extracted by the feature pattern extraction unit 2, and the like. Regarding the effectiveness. for example, the evaluation values of the prediction model are compared before and after taking countermeasure, and the difference thereof is used as the effectiveness.

The countermeasure storage unit 72 is, for example, a storage device such as a database. Although the countermeasure storage unit 72 is provided inside the learning support apparatus 1C in FIG. 7, it may be provided outside the learning support apparatus 1C.

In the learning phase, the cause estimation rule learning unit 73 learns the error cause estimation rule (model) by using the error cause and the pattern of the feature amount corresponding to the error cause. Specifically, the cause estimation rule learning unit 73 first acquires error cause and a pattern of feature amounts corresponding to the error cause from the cause storage unit 71.

Subsequently, the cause estimation rule learning unit 73 generates an error cause estimation rule using the acquired error cause and the pattern of feature amounts, and stores the generated error cause estimation rule in the cause estimation rule storage unit 52.

The error cause estimation rule can be learned by using the stored feature pattern and the error cause, and learning the prediction model with the feature pattern as an explanatory variable and the error cause as an objective variable. The pattern of feature amounts is stored, for example, as a combination of feature amount values.

In this case, the pattern of feature amount can be expressed as a matrix in which all possible feature amount values are columns, each feature pattern is a row, the feature amount values included in each pattern of feature amount are 1, and the feature amount values not included are 0. This matrix is used as an explanatory variable, and a column vector including an error cause associated with each feature pattern as an element is used as an objective variable.

Then, the error cause estimation rule can be learned by learning the prediction model from these data with a learning method such as multivariate regression or regression by GBDT.

Further, by using a probability distribution estimation method such as Bayesian regression as the learning method of the error cause estimation rule, when a certain feature amount pattern is given, the certainty of each error cause can be obtained.

In the learning phase, the countermeasure estimation rule learning unit 74 learns the countermeasure estimation rule (model) by using the countermeasure, the pattern corresponding to the feature amount of the countermeasure, and the effectiveness corresponding to the error cause. Specifically, the countermeasure estimation rule learning unit 74 first acquires the countermeasure, the pattern of the feature amount corresponding to the countermeasure, and the effectiveness corresponding to the countermeasure from the countermeasure storage unit 72.

Subsequently, the countermeasure estimation rule learning unit 74 generates a countermeasure estimation rule using the acquired countermeasure, the pattern of feature amounts, and the effectiveness, and stores the generated countermeasure estimation rule in the countermeasure estimation rule storage unit 54.

Learning of the countermeasure estimation rule is obtained by learning a prediction model with the pattern of feature amounts as an explanatory variable and the countermeasure as an objective variable. The pattern of feature amounts can be expressed as a matrix similar to that at the time of learning the error cause estimation rule. As a method of expressing the countermeasure, for example, it can be expressed as a categorical variable in which a unique identifier is assigned to a possible countermeasure.

In the case of this objective variable, since it is a prediction task of a plurality of categories, it is possible to learn the countermeasure estimation rule by a method such as determination tree determination or GBDT determination.

In learning of the countermeasure estimation rule, the effectiveness may be used as the weight of the sample at the time of learning. In the learning of the prediction model, in general, the difference between the past actual value and the predicted value by the model in the middle of learning is evaluated for each sample, and the sum is defined as a loss function.

For example, a square error or a log-likelihood function is used for the difference between the actual value and the predicted value. Optimal model parameters are determined by minimizing this loss function, and a prediction model is obtained. It is possible to learn emphasis on the examples of countermeasures with high effectiveness by using a weighted sum, as loss function, with effectiveness as weight from the sum of the differences for each sample, and it is possible to obtain a model predicting countermeasures with high effectiveness.

As a result, it is possible to learn and update the error cause estimation rule and the countermeasure estimation rule according to a new pattern of feature amounts, a residual tendency, and the like. The error cause estimation rule and the countermeasure estimation rule may be learned as one prediction model at the same time.

[Apparatus Operation]

Next, the operation of the learning support apparatus according to the third example embodiment will be described with reference to FIG. 8. FIG. 8 is a diagram showing an example operation of the learning support apparatus according to the third example embodiment. In the following description, FIG. 7 will be referred to as needed in the following description. Further, in the third example embodiment, the learning support method is implemented by causing the learning support apparatus to operate. Accordingly, the following description of the operations of the learning support apparatus is substituted for the description of the learning support method in the third example embodiment.

As shown in FIG. 8, the user first gives an instruction for re-learning to the prediction model management apparatus 11 and the learning support apparatus 1C through the input device 20 (step C1).

Next, the feedback unit 70 stores feedback related to the error cause in the cause storage unit 71 (step C2). Specifically, in step C2, the cause storage unit 71 stores, for example, the error cause, the pattern of feature amount corresponding to the error cause, and the effectiveness of the error cause in association with each other as feedback.

Further, the feedback unit 70 stores feedback related to the countermeasure in the countermeasure storage unit 72 (step C3). Specifically, in step C3, the countermeasure storage unit 72 stores, for example, a countermeasure for improving the error, the corresponding pattern of feature amounts, and the effectiveness of the countermeasure as feedback.

The order of processing steps C2 and C3 may be reversed. Alternatively, the processes of steps C2 and C3 may be executed in parallel.

Next, in the learning phase, the cause estimation rule learning unit 73 learns the error cause estimation rule (model) by using the error cause, the pattern of feature amounts corresponding to the error cause, and the effectiveness corresponding to the error cause (step C4). Specifically, in step C4, the cause estimation rule learning unit 73 first acquires the error cause, the pattern of feature amounts corresponding to the error cause, and the effectiveness corresponding to the error cause from the cause storage unit 71.

Subsequently, in step C4, the cause estimation rule learning unit 73 generates an error cause estimation rule using the acquired error cause, the pattern of feature amounts, and the effectiveness, and stores the generated error cause estimation rule in the estimation rule storage unit 52.

Further, in the learning phase, the countermeasure estimation rule learning unit 74 learns the countermeasure estimation rule (model) by using the countermeasure, the pattern corresponding to the feature amount of the countermeasure, and the effectiveness corresponding to the error cause (step C5). Specifically, in step C5, the countermeasure estimation rule learning unit 74 first acquires the countermeasure, the pattern of the feature amount corresponding to the countermeasure, and the effectiveness corresponding to the countermeasure from the countermeasure storage unit 72.

Subsequently, in step C5, the countermeasure estimation rule learning unit 74 generates a countermeasure estimation rule using the acquired countermeasure, the pattern of feature amounts, and the effectiveness, and stores the generated countermeasure estimation rule in the countermeasure estimation rule storage 54.

The order of processing steps C4 and C5 may be reversed. Alternatively, the processes of steps C4 and C5 may be executed in parallel.

After that, the processes of steps A1 to A3 and steps B1 to B4 shown in FIG. 6 are executed by using the error cause estimation rule and the countermeasure estimation rule generated in the third example embodiment.

[Effect of the First Example Embodiment]

As described above, according to the third example embodiment, it is possible to generate information such as a pattern of feature amounts and an error contribution of the pattern of feature amounts. Therefore, it is possible to provide the user with the information used to improve the prediction accuracy of the prediction model through the output device 30. Therefore, the user can easily perform the work of improving the prediction accuracy of the prediction model.

Further, according to the third example embodiment, it is possible to estimate the error cause and the countermeasure for solving the error cause. Therefore, it is possible to generate information of not only the pattern of feature amount and the error contribution of the pattern of feature amount but also information such as the error cause and the countermeasures. Therefore, the information used for improving the prediction accuracy of the prediction model can be further provided to the user through the output device 30. Therefore, the user can easily perform the work of improving the prediction accuracy of the prediction model.

Further, according to the third example embodiment, it is possible to automatically generate the error cause estimation rule, the countermeasure estimation rule, or both. Therefore, the user can easily perform the work of improving the prediction accuracy of the prediction model.

[Program]

A program in the third example embodiment may be a program that causes a computer to execute steps C1 to C5 shown in FIG. 8. It is possible to realize the learning support apparatus and learning support method according to the third example embodiment by installing this program onto a computer and executing the program. If this is the case, the processor of the computer functions as the sample classification unit 4, the feature pattern extraction unit 2, the error contribution calculation unit 3, the cause estimation unit 51, the countermeasure estimation unit 53, the output information generation unit 12, the feedback unit 70, the cause storage unit 71, the countermeasure storage unit 72, the cause estimation rule learning unit 73, and the countermeasure estimation rule learning unit 74, and executes processing.

Also, the program according to the third example embodiment may be executed by a computer system constructed with a plurality of computers. In this case, for example, the computers may respectively function as the sample classification unit 4, the feature pattern extraction unit 2, the error contribution calculation unit 3, the cause estimation unit 51, the countermeasure estimation unit 53, the output information generation unit 12, the feedback unit 70, the cause storage unit 71, the countermeasure storage unit 72, the cause estimation rule learning unit 73, and the countermeasure estimation rule learning unit 74.

[Physical Configuration]

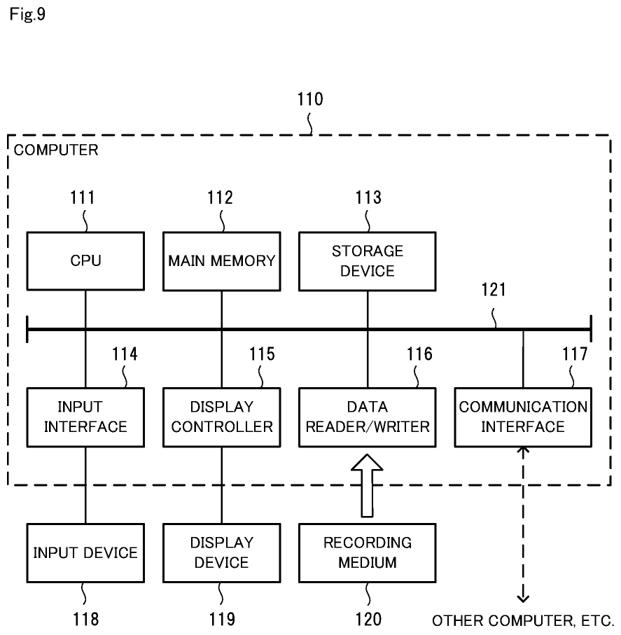

Here, a computer that realizes the learning support apparatus by executing the program in the first, second, and third example embodiment will be described with reference to FIG. 9. FIG. 9 is a block diagram showing an example of a computer that realizes the learning support apparatus according to the first, second, and third example embodiments.

As illustrated in FIG. 9, a computer 110 includes a CPU 111, a main memory 112, a storage device 113, an input interface 114, a display controller 115, a data reader/writer 116, and a communication interface 117. These components are connected via a bus 121 so as to be capable of performing data communication with one another. Note that the computer 110 may include a graphics processing unit (GPU) or a field-programmable gate array (FPGA) in addition to the CPU 111 or in place of the CPU 111.

The CPU 111 loads the program (codes) in the present example embodiment, which is stored in the storage device 113, onto the main memory 112, and performs various computations by executing these codes in a predetermined order. The main memory 112 is typically a volatile storage device such as a dynamic random access memory (DRAM) or the like. Also, the program in the present example embodiment is provided in a state such that the program is stored in a computer readable recording medium 120. Note that the program in the present example embodiment may also be a program that is distributed on the Internet, to which the computer 110 is connected via the communication interface 117.

In addition, specific examples of the storage device 113 include semiconductor storage devices such as a flash memory, in addition to hard disk drives. The input interface 114 mediates data transmission between the CPU 111 and input equipment 118 such as a keyboard and a mouse. The display controller 115 is connected to a display device 119, and controls the display performed by the display device 119.

The data reader/writer 116 mediates data transmission between the CPU 111 and the recording medium 120, and executes the reading of the program from the recording medium 120 and the writing of results of processing in the computer 110 to the recording medium 120. The communication interface 117 mediates data transmission between the CPU 111 and other computers.

Also, specific examples of the recording medium 120 include a general-purpose semiconductor storage device such as CF (CompactFlash (registered trademark)) or SD (Secure Digital), a magnetic recording medium such as a flexible disk, and an optical recording medium such as CD-ROM (compact disk read-only memory).

Note that the learning support apparatus in the present example embodiment can also be realized by using pieces of hardware corresponding to the respective units, rather than using a computer on which the program is installed. Furthermore, a part of the learning support apparatus may be realized by using a program, and the remaining part of learning support apparatus may be realized by using hardware.

[Supplementary Note]

The following Supplementary notes will be further disclosed with respect to the above example embodiments. A part or all of the above-described example embodiments can be expressed by the following descriptions (Supplementary note 1) to (Supplementary note 18), however the present invention is not limited to the following description.

(Supplementary Note 1)

A learning support apparatus according to an example aspect of the present invention includes:

a feature pattern extraction unit that extracts a pattern of feature amounts that differentiates samples classified based on residuals using the classified samples and feature amounts used for learning a predictive model; and

an error contribution calculation unit that calculates an error contribution to a prediction error in the pattern of feature amounts using the extracted pattern of feature amounts and the residuals.

(Supplementary Note 2)

The learning support apparatus according to Supplementary note 1, further comprising:

a cause estimation unit that estimates an error cause using an error cause estimation rule for estimating the error cause from the pattern of feature amounts.

(Supplementary Note 3)

The learning support apparatus according to Supplementary note 2, further comprising:

a cause estimation rule learning unit that generates the error cause estimation rule by learning using the error cause and the pattern of feature amounts.

(Supplementary Note 4)

The learning support apparatus according to Supplementary note 1 or 2, further comprising:

a countermeasure estimation unit that estimates a countermeasure by using a countermeasure estimation rule for estimating the countermeasure for eliminating the error cause from the pattern of feature amounts.

(Supplementary Note 5)

The learning support apparatus according to Supplementary note 4, further comprising:

a countermeasure estimation rule learning unit that generates the countermeasure estimation rule by learning using the countermeasure and the pattern of feature amounts.

(Supplementary Note 6)

The learning support apparatus according to Supplementary note 1, wherein

an output information is generated using the pattern of feature amounts and the error contribution, and output to an output device.

(Supplementary Note 7)

A learning support method according to an example aspect of the present invention includes:

(a) extracting a pattern of feature amounts that differentiates samples classified based on residuals using the classified samples and feature amounts used for learning a predictive model; and

(b) calculating an error contribution to a prediction error in the pattern of feature amounts using the extracted pattern of feature amounts and the residuals.

(Supplementary Note 8)

The learning support method according to Supplementary note 7, further comprising:

(c) estimating an error cause using an error cause estimation rule for estimating the error cause from the pattern of feature amounts.

(Supplementary Note 9)

The learning support method according to Supplementary note 8, further comprising:

(d) generating the error cause estimation rule by learning using the error cause and the pattern of feature amounts.

(Supplementary Note 10)

The learning support method according to Supplementary note 7 or 8, further comprising:

(e) estimating a countermeasure by using a countermeasure estimation rule for estimating the countermeasure for eliminating the error cause from the pattern of feature amounts.

(Supplementary Note 11)

The learning support method according to Supplementary note 10, further comprising:

(f) generating the countermeasure estimation rule by learning using the countermeasure and the pattern of feature amounts.

(Supplementary Note 12)

The learning support method according to Supplementary note 7, wherein

an output information is generated using the pattern of feature amounts and the error contribution, and output to an output device.

(Supplementary Note 13)

a computer-readable recording medium according to an example aspect of the present invention includes a program recorded thereon, the program including instructions that cause a computer to carry out:

(a) extracting a pattern of feature amounts that differentiates samples classified based on residuals using the classified samples and feature amounts used for learning a predictive model; and

(b) calculating an error contribution to a prediction error in the pattern of feature amounts using the extracted pattern of feature amounts and the residuals.

(Supplementary Note 14)

The computer-readable recording medium for recording a program according to Supplementary note 13 further including instructions that cause the computer to:

(c) estimating an error cause using an error cause estimation rule for estimating the error cause from the pattern of feature amounts.

(Supplementary Note 15)

The computer-readable recording medium for recording a program according to Supplementary note 14 further including instructions that cause the computer to:

(d) generating the error cause estimation rule by learning using the error cause and the pattern of feature amounts.

(Supplementary Note 16)

The computer-readable recording medium for recording a program according to Supplementary note 13 or 14 further including instructions that cause the computer to:

(e) estimating a countermeasure by using a countermeasure estimation rule for estimating the countermeasure for eliminating the error cause from the pattern of feature amounts.

(Supplementary Note 17)

The computer-readable recording medium for recording a program according to Supplementary note 16 further including instructions that cause the computer to:

(f) generating the countermeasure estimation rule by learning using the countermeasure and the pattern of feature amounts.

(Supplementary Note 18)

The computer-readable recording medium for recording a program according to Supplementary note 13 further including instructions that cause the computer to:

generating an output information using the pattern of feature amounts and the error contribution, and outputting to an output device.

Although the present invention has been described above with reference to the example embodiments, the present invention is not limited to the above example embodiments. Various changes that can be understood by those skilled in the art can be made within the scope of the present invention in terms of the structure and details of the present invention.

### INDUSTRIAL APPLICABILITY

As described above, according to the present invention, it is possible to generate information used for improving the prediction accuracy of the prediction model and present the generated information to the user. The present invention is useful in fields where it is necessary to improve the prediction accuracy of a prediction model.

### REFERENCE SIGNS LIST

1, 1A, 1B, 1C Learning support apparatus

2 Feature pattern extraction unit

3 Error contribution calculation unit

4 Sample classification unit

10A, 10B, 10C Predictive model management system

20 Input device

30 Output device

40 Analytical data storage unit

11 Predictive model management apparatus

101 Model learning unit

102 Model evaluation unit

103 Residual calculation unit

12 Output information generation unit

13 Residual storage unit

51 Cause estimation unit

52 Cause estimation rule storage unit

53 Countermeasure estimation unit

54 Countermeasure estimation rule storage unit

70 Feedback unit

71 Cause memory unit

72 Countermeasure memory unit

73 Cause estimation rule learning unit

74 Countermeasure estimation rule learning unit

110 Computer

111 CPU

112 Main memory

113 Storage device

114 Input interface

115 Display controller

116 Data reader/writer

117 Communication interface

118 Input device

119 Display device

120 Recording medium

121 Bus

What is claimed is:

1. A learning support apparatus comprising:
a feature pattern extraction unit that extracts a pattern of feature amounts that differentiates samples classified based on residuals using the classified samples and feature amounts used for learning a predictive model; and
an error contribution calculation unit that calculates an error contribution to a prediction error in the pattern of feature amounts using the extracted pattern of feature amounts and the residuals.

2. The learning support apparatus according to claim 1, further comprising:
a cause estimation unit that estimates an error cause using an error cause estimation rule for estimating the error cause from the pattern of feature amounts.

3. The learning support apparatus according to claim 2, further comprising:
a cause estimation rule learning unit that generates the error cause estimation rule by learning using the error cause and the pattern of feature amounts.

4. The learning support apparatus according to claim 1, further comprising:
a countermeasure estimation unit that estimates a countermeasure by using a countermeasure estimation rule for estimating the countermeasure for eliminating the error cause from the pattern of feature amounts.

5. The learning support apparatus according to claim 4, further comprising:
a countermeasure estimation rule learning unit that generates the countermeasure estimation rule by learning using the countermeasure and the pattern of feature amounts.

6. The learning support apparatus according to claim 1, wherein an output information is generated using the pattern of feature amounts and the error contribution, and output to an output device.

7. A learning support method comprising:
extracting a pattern of feature amounts that differentiates samples classified based on residuals using the classified samples and feature amounts used for learning a predictive model; and
calculating an error contribution to a prediction error in the pattern of feature amounts using the extracted pattern of feature amounts and the residuals.

8. The learning support method according to claim 7, further comprising:
estimating an error cause using an error cause estimation rule for estimating the error cause from the pattern of feature amounts.

9. The learning support method according to claim 8, further comprising:
generating the error cause estimation rule by learning using the error cause and the pattern of feature amounts.

10. The learning support method according to claim 7, further comprising:
estimating a countermeasure by using a countermeasure estimation rule for estimating the countermeasure for eliminating the error cause from the pattern of feature amounts.

11. The learning support method according to claim 10, further comprising:
generating the countermeasure estimation rule by learning using the countermeasure and the pattern of feature amounts.

12. The learning support method according to claim 7, wherein
an output information is generated using the pattern of feature amounts and the error contribution, and output to an output device.

13. A non-transitory computer-readable recording medium for recording a program including instructions that cause a computer to:
extracting a pattern of feature amounts that differentiates samples classified based on residuals using the classified samples and feature amounts used for learning a predictive model; and
calculating an error contribution to a prediction error in the pattern of feature amounts using the extracted pattern of feature amounts and the residuals.

14. The non-transitory computer-readable recording medium for recording a program according to claim 13 further including instructions that cause the computer to:
estimating an error cause using an error cause estimation rule for estimating the error cause from the pattern of feature amounts.

15. The non-transitory computer-readable recording medium for recording a program according to claim 14 further including instructions that cause the computer to:
generating the error cause estimation rule by learning using the error cause and the pattern of feature amounts.

16. The non-transitory computer-readable recording medium for recording a program according to claim 13 further including instructions that cause the computer to:
estimating a countermeasure by using a countermeasure estimation rule for estimating the countermeasure for eliminating the error cause from the pattern of feature amounts.

17. The non-transitory computer-readable recording medium for recording a program according to claim 16 further including instructions that cause the computer to:
generating the countermeasure estimation rule by learning using the countermeasure and the pattern of feature amounts.

18. The non-transitory computer-readable recording medium for recording a program according to claim 13 further including instructions that cause the computer to:
generating an output information using the pattern of feature amounts and the error contribution, and outputting to an output device.
